(19) United States
(12) Patent Application Publication
(10) Pub. No.: US 2005/0274101 A1
(43) Pub. Date: Dec. 15, 2005

(54) Rope structure

(76) Inventor: Chin-Fa Wang, Chang Hua (TW)

Correspondence Address: Wang Chin-Fa, P.O. Box 487, Chang-Hua City, 500, TW

(21) Appl. No.: 10/865,833

(22) Filed: Jun. 14, 2004

(51) Int. Cl. D02G 3/36; E06C 5/26; E06C 1/52

(52) U.S. Cl. 57/241

(57) ABSTRACT

A rope includes two groups of yarn wires which are respectively coated by a coating made of PUC foam plastic. The coatings are arranged in parallel with each other and connected by a connection portion. The coatings can be dyed as different colors. Two or more ropes can be woven together to be a reinforced rope when necessary.

### FIELD OF THE INVENTION

The present invention relates to a rope composed of two groups of yarn wires and each group is coated by a plastic foam coating. The two respective plastic coatings are connected as one piece.

### BACKGROUND OF THE INVENTION

A conventional rope is made by plant vines which have natural colors and good flexibility so that people use the vines to make variety of products such as chairs, baskets or pads. Nevertheless, the vast quantity of requirement for the natural vines hurts the natural source badly so that people uses plastic ropes to replace the natural vines ropes. Yarns are coated to the plastic ropes and the yarns are able to be dyed with desired colors. The plastic ropes are then woven by machine to be groups which are conveniently woven to be desired patterns. However, the plastic ropes lack flexibility and the yarns are easily broken during machine weaving. Quality control becomes a problem for the manufacturers.

The present invention intends to provide a durable and flexible reinforced rope which is composed of at least two groups of yarn wires and each group is coated by a plastic coating. The two respective coatings are connected as one piece.

### SUMMARY OF THE INVENTION

The present invention relates to a rope which comprises two groups of yarn wires and each group is coated by a coating made of PUC foam plastic. The coatings are arranged in parallel with each other and connected by a connection portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the two groups of yarn wires are coated with two respective coatings;

FIG. 2 is a cross sectional view to show the coatings each have a circular cross section;

FIG. 3 is a cross sectional view to show the coatings each have a triangular cross section;

FIG. 4 shows that the two groups are woven with each other, and

FIG. 5 shows that two ropes each composed of two groups are woven with each other.

### DETAILED DESCRIPTION OF THE PREFERRED EMBODIMENT

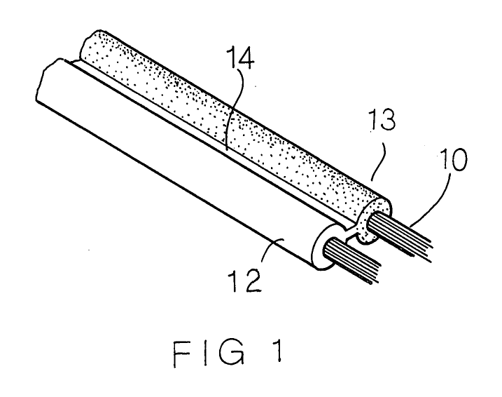

Referring to FIGS. 1 to 3, the rope of the present invention comprises two groups of yarn wires 10 and each group is coated by a coating 12/13 made of PUC foam plastic. The coatings 12, 13 are arranged in parallel with each other and connected by a connection portion 14. The coatings 12, 13 can be dyed as different colors.

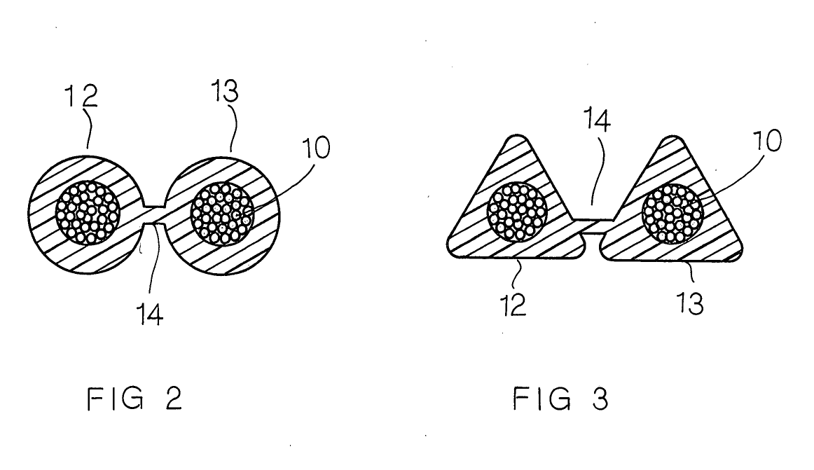

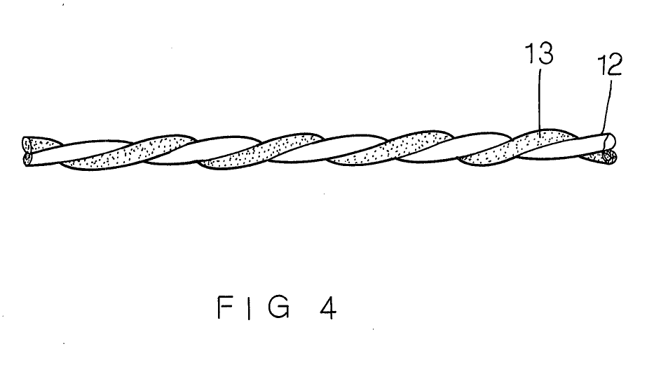

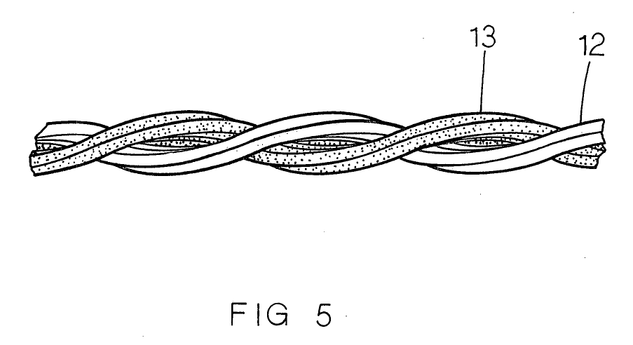

As shown in FIGS. 2 and 3, each of the coatings 12, 13 can be a circular or polygonal cross section such as triangular cross section. As shown in FIG. 4, the two coatings 12, 13 can also be individual and separated and the two groups of the yarn wires 10 can be spirally woven with each other. Two ropes each composed of two groups of yarn wires can be woven with each other to form a reinforce rope as desired.

The rope of the present invention is easily to be manufactured and includes a plastic foam coating which is durable and has cushion feature so that the rope can be used in many ways and applications.

While we have shown and described the embodiment in accordance with the present invention, it should be clear to those skilled in the art that further embodiments may be made without departing from the scope of the present invention.

1. A rope comprising:
two groups of yarn wires and each group being coated by a coating, the coatings being arranged in parallel with each other and connected by a connection portion, the coatings and the connection portion made of PUC foam plastic.

2. The rope as claimed in claim 1, wherein each of the coatings has a polygonal cross section.

3. The rope as claimed in claim 1, wherein each of the coatings has a circular cross section.

4. The scooter as claimed in claim 1, wherein the coatings have different colors.
